(19) United States
(12) Patent Application Publication
(10) Pub. No.: US 2016/0145421 A1
(43) Pub. Date: May 26, 2016

(54) MICROSPHERES

(71) Applicant: MERCK PATENT GMBH, Darmstadt (DE)

(72) Inventors: Volker WILHELM, Lorsch (DE); Hans-Juergen BREHM, Lindenfels (DE)

(73) Assignee: Merck Patent GmbH, Darmstadt (DE)

(21) Appl. No.: 14/900,213

(22) PCT Filed: May 30, 2014
(86) PCT No.: PCT/EP2014/001466

§ 371 Date: Dec. 21, 2015

(30) Foreign Application Priority Data
Jun. 27, 2013 (DE) 10 2013 010 703.2

(51) Int. Cl. C08K 9/10

(52) U.S. Cl. CPC C08K 9/10

(57) ABSTRACT

The present invention relates to microspheres, to a process for the production thereof, and to the use thereof, preferably as laser-absorbing additive.

The present invention relates to microspheres, to a process for the production thereof, and to the use thereof, preferably as laser-absorbing additive.

The identification marking of products is becoming increasingly important in virtually all branches of industry. For example, it is frequently necessary to apply production dates, expiry dates, bar codes, company logos, serial numbers, etc., to plastic parts or flexible plastic films. These inscriptions are currently usually carried out using conventional techniques, such as printing, hot embossing, other embossing methods or labelling. In particular in the case of plastics, however, increasing importance is being attached to a contactless, very rapid and flexible inscription method using lasers. With this technique, it is possible to apply graphic prints, such as, for example, bar codes, at high speed, even to non-planar surfaces. Since the inscription is located within the plastic article itself, it is durably abrasion-resistant.

It is generally known that, on irradiation with laser light, certain materials, such as polymers, such as, for example, plastics and resins, can absorb energy from the laser light and convert this energy into heat, which is able to induce a colour change reaction (=inscription) in the material. Laser-light absorbers are used to improve the absorption of laser light if the intrinsic ability of a polymer with respect to the absorption of laser light is inadequate.

Many plastics, for example polyolefins and polystyrenes, have hitherto been difficult or even impossible to inscribe using a laser. A CO₂ laser which emits infrared light in the region of 10.6 μm only gives rise to a very weak, virtually illegible inscription on polyolefins or polystyrenes, even on use of high power. In the case of polyurethane elastomers and polyether-ester elastomers, there is no interaction with Nd-YAG lasers, but embossing occurs on use of CO₂ lasers.

A plastic must not reflect or transmit any laser light, since then no interaction occurs. Nor must excessively strong absorption take place, however, since in this case the plastic evaporates, leaving only an embossing. The absorption of laser beams, and therefore the interaction with the material, depends on the chemical structure of the composition and on the laser wavelength used. It is frequently necessary to add suitable additives, such as absorbers, in order to render plastics laser-inscribable.

The successful absorber should have a very pale inherent colour and/or only have to be employed in very small amounts. The prior art discloses that the contrast agent antimony trioxide satisfies such criteria, as described in U.S. Pat. No. 4,816,374, U.S. Pat. No. 6,214,917 B1, WO 01/0719 and WO 2009/003976. However, antimony trioxide is toxic and suspected of being carcinogenic, and antimony-free laser-inscription additives are therefore desired.

Antimony- or antimony oxide-free laser-inscription additives are known from the literature. For example, US 2007/02924 describes laser additives based on compounds of the formula MOCl, where M is either As, Sb or Bi, as well as BiONO₃, Bi₂O₂CO₃, BiOOH, BiOF, BiOBr, Bi₂O₃, BiOC₃H₅O₇, etc. The use of elemental carbon as laser additive is known, for example, from WO 2011/085779 A1.

The disadvantage of antimony-free laser-inscription additives is that they are not suitable for all types of plastic. In certain plastic compositions (polymer matrix), the additives exhibit strong discolouration if high processing temperatures, i.e. >220° C., are employed.

The object of the present invention is therefore to find a heavy-metal-free laser additive which does not have the above-mentioned disadvantages and at the same time is physiologically acceptable. The laser additive should furthermore enable high-contrast inscription on exposure to laser light and have significantly improved contrast compared with the laser additives from the prior art both at low and also at high inscription speeds of the laser.

Microspheres which serve as laser absorber and are based on core/shell particles are known, for example, from WO 2004/050766 A1, WO 2004/050767 A1 and WO 2009/003976 A1.

Surprisingly, it has now been found that microspheres which consist of a core/shell particle dispersed in a polyolefin matrix (=carrier polymer) and which comprise, as absorber, a mixture of elemental carbon and at least one metal oxide and/or metal titanate in the core and comprise, as colour former, at least one non-olefinic polymer compound, and the shell comprises at least one compatibiliser exhibit none of the above-mentioned disadvantages and are eminently suitable as laser-inscription additive for all types of polymer compositions, preferably thermoplastic polymers.

The present invention thus relates to microspheres consisting of a core/shell particle dispersed in a polyolefin matrix, characterised in that the core comprises elemental carbon, at least one metal oxide and/or at least one metal titanate and at least one non-olefinic polymer, and the shell comprises at least one compatibiliser.

On irradiation with laser light, polymer compositions, such as, for example, plastics, which comprise the microspheres according to the invention exhibit unexpectedly high contrast with a broad range of laser systems, even at high inscription speeds. Owing to the synergistic effect between laser-light absorber(s) and colour former(s) in the core and the polymer of the shell, the pale-coloured microspheres can serve as laser absorbers having improved laser-inscription performance with respect to contrast and speed compared with the known laser additives which are commercially available and are described in the literature. In addition, the improved performance results in a lower dosage in the end product, resulting in a cost reduction being achieved. Furthermore, the lower dosage of the laser additive according to the invention in the end product (polymer matrix) results in the properties, such as, for example, the mechanical properties, of the polymer to be inscribed only being affected insignificantly or not at all. Since the absorber mixture of carbon and metal oxide and/or metal titanate is regarded as being physiologically acceptable, it can be employed both in medical applications and also in the foods sector, for example in plastic packaging.

The laser-light absorber used can be prepared from metal oxides and metal titanates that are capable of absorbing laser light of a certain wavelength. In the preferred embodiment, this wavelength is between 157 nm and 10.6 μm, the customary wavelength range of lasers. If lasers having longer or shorter wavelengths were to become available, other absorbers may likewise be suitable for an application. Examples of such lasers which operate in the said range are CO₂ lasers (10.6 μm), Nd:YAG or Nd:YVO₄ lasers (1064 nm, 532 nm, 355 nm, 266 nm) and excimer lasers of the following wavelengths: F₂ (157 nm), ArF (193 nm), KrCl (222 nm), KrF (248 nm), XeCl (308 nm) and XeF (351 nm), FAYb fibre lasers, diode lasers and diode array lasers. Preference is given to the use of Nd:YAG lasers, Nd:YVO₄ lasers and CO₂ lasers since these types operate at a wavelength which are particularly suitable for the induction of a thermal process for inscription purposes.

Suitable examples of the laser-light absorber are one or more metal oxides, preferably selected from the group TiO₂, ZrO₂, V₂O₅, ZnO, Al₂O₃, in particular TiO₂, and/or one or more metal titanates selected from the group calcium titanate, barium titanate, magnesium titanate, in particular barium titanate.

The absorber is particularly preferably a mixture of elemental carbon with only one metal oxide or with only one metal titanate.

In a preferred embodiment, the laser-light absorber is a mixture of elemental carbon and titanium dioxide or elemental carbon and barium titanate.

The weight ratio of elemental carbon to metal oxide and/or metal titanate is preferably 0.001:99.999% to 0.1:99.9%.

The elemental carbon is preferably used in the form of carbon black or a black pigment. The carbon here preferably has average primary particle sizes of 1-100 nm, in particular 10-50 nm.

The microspheres preferably comprise 10-90% by weight, in particular 20-80% by weight and particularly preferably 25-75% by weight of absorber, based on the microspheres as such (i.e. not dispersed in the polyolefin matrix). The microspheres very particularly preferably comprise a mixture of carbon and titanium dioxide or a mixture of carbon and barium titanate, preferably in amounts of 20-80% by weight. If the microspheres are dispersed in the polyolefin matrix, the proportion of absorber is preferably 12.5-25%, based on the entire formulation, i.e. the microspheres according to claim 1 dispersed in the polyolefin matrix.

The mixture of carbon and metal oxide and/or metal titanate is preferably in the form of agglomerates or spheres.

The absorber, i.e. the mixture of carbon and metal oxide/titanate, is present in the microsphere, for example, in the form of spheres. The particle size of the absorber is determined by the requirement that the absorber must be capable of being mixed into the polymer in the core. It is known to a person skilled in the art in the area that this miscibility is determined by the total surface area of a certain amount by weight of the absorber and that the person skilled in the art will readily be able to determine the lower limit of the particle size of the absorber to be mixed in if the desired size of the microspheres and the desired amount of absorber to be mixed in are known.

Elemental carbon is commercially available, for example from Evonik under the trade name Printex® 90 or from Cabot under the trade name Monarch 1300.

Suitable metal oxides are commercially available, for example Kronos 2900 from Kronos or HOMBITEC RM130F from Sachtleben.

Suitable metal titanates are, for example, BaTiO₃, MgTiO₃, CaTiO₃, for example 99% calcium titanate from ABCR GmbH & Co. KG (d₅₀ max. 3.5 μm), 99+% calcium titanium oxide from Alfa Aesar, 99.9% barium titanate nano from ABCR GmbH & Co. KG (approx. 400 nm; BET 2.3-2.7 m²/g).

The absorber used preferably has an average particle size in the range 0.1-10 μm, in particular 0.13-4 μm and very particularly preferably in the range 0.15-3 μm. The absorber TiO₂ preferably used preferably has an average particle size in the range 0.13-4 μm and very particularly preferably in the range 0.15-3 μm.

The core of the microspheres comprises at least one non-olefinic polymer, which is preferably a thermoplastic polymer.

Examples of particularly preferred thermoplastic polymers are preferably selected from the following group:
polyphenylene oxide (PPO)
polystyrene (PS)
styrene plastics
polyesters
polysulfones
polycarbonates (PC)
polyurethanes
   or mixtures thereof.

Examples of polyesters are polybutylene terephthalate (PBT) or polyethylene terephthalate (PET).

An example of styrene plastics is styrene-acrylonitrile.

In order to select a suitable polymer, a person skilled in the art in the area will principally be guided by the desired degree of adhesion to the absorbers and the requisite colour-formation ability.

In a preferred embodiment, the core comprises PBT, PPO/PS, PET or polycarbonate (PC) or mixtures thereof as colour former.

In a particularly preferred embodiment, the core of the microspheres consists of
20-90% by weight of absorber, preferably elemental carbon/TiO₂
10-80% by weight of a non-olefinic polymer colour former, in particular PBT, PET, PPO/PS or PC,
   based on the core/shell particle.

The adhesion of the polymer of the core to the mixture of carbon and metal oxide and/or metal titanate is generally higher than the adhesion of core and compatibiliser (=shell). This ensures the integrity of the microspheres during processing thereof.

A chemical reaction between the absorber and the polymer in the core should be avoided. Such chemical reactions could cause decomposition of the absorber and/or polymer, resulting in undesired by-products, discolouration and poor mechanical and inscription properties.

In the microspheres according to the invention, the core is embedded in a shell which comprises a compatibiliser.

The compatibiliser is generally responsible, inter alia, for forming the microspheres during production in the case of the use of (reactive) extrusion. In a preferred embodiment, the compatibiliser (=shell) and the polymer of the core have at least one chain segment having different polarity. In addition, the compatibiliser, owing to its segments having different polarity than the core, improves the integrity of the core.

The compatibiliser is preferably a thermoplastic polymer. Preferred thermoplastic polymers either contain functional groups, such as, for example, carboxylic acid groups, alkoxysilane groups, alcohol groups, or are graft or block copolymers having chain segments which are only partially compatible with the core, such as, for example, styrene-ethylene/butylene-styrene (SEBS) block copolymers. The compatibiliser of the present invention is preferably a thermoplastic polymer. In a particularly preferred embodiment, the compatibiliser is a grafted thermoplastic polymer or a block copolymer. In a very particularly preferred embodiment, the grafted thermoplastic polymer is a grafted polyolefin or a styrene-ethylene/butylene-styrene block copolymer.

Polyolefin polymers are, for example, homo- and copolymers comprising one or more olefin monomers which can be grafted to an ethylenically unsaturated, functionalised compound. Examples of suitable polyolefin polymers are ethylene and propylene homo- and copolymers. Examples of suitable ethylene polymers are all thermoplastic homopolymers of ethylene and copolymers of ethylene with one or more α-olefins having 3-10 carbon atoms as comonomer, in particular propylene, isobutene, 1-butene, 1-hexene, 4-methyl-1-pentene and 1-octene, which can be prepared, for example, using known catalysts, inter alia Ziegler-Natta, Phillips and metallocene catalysts. The amount of comonomer is generally 0-50% by weight, preferably 5-35% by weight, based on the weight of the entire composition. Such polyethylenes are, for example, known as high-density polyethylene (HDPE), low-density polyethylene (LDPE), linear low-density polyethylene (LLDPE), linear very low-density polyethylene (VL(L)DPE) and metallocene-polyethylene (m-PE).

Suitable polyethylenes preferably have a density of 860-970 kg/m³, measured at 23° C. in accordance with ISO 1183. Examples of suitable propylene polymers are homopolymers of propylene and copolymers of propylene with ethylene in which the proportion of ethylene is at most 30% by weight and preferably at most 25% by weight.

Examples of suitable ethylenically unsaturated, functionalised compounds are the unsaturated carboxylic acids as well as esters, anhydrides and metal or non-metal salts thereof. The ethylenic unsaturation in the compound is preferably conjugated with a carbonyl group. Examples are acrylic, methacrylic, maleic, fumaric, itaconic, crotonic, methylcrotonic and cinnamic acid as well as esters, anhydrides and possible salts thereof. Of the compounds mentioned containing at least one carbonyl group, maleic anhydride is preferred.

Examples of suitable ethylenically unsaturated functionalised compounds containing at least one epoxide ring are, for example, glycidyl esters of unsaturated carboxylic acids, glycidyl ethers of unsaturated alcohols and of alkylphenols and vinyl and allyl esters of epoxycarboxylic acids. Glycidyl methacrylate is particularly suitable.

Examples of suitable ethylenically unsaturated functionalised compounds having at least one amine functionality are amine compounds containing at least one ethylenically unsaturated group, for example allylamine, propenyl-, butenyl-, pentenyl- and hexenylamine, amine ethers, for example isopropenylphenylethylamine ether. The amine group and the unsaturation should be in such an arrangement relative to one another that they do not influence the grafting reaction to an undesired extent. The amines may be unsubstituted, but may also be substituted by, for example, alkyl and aryl groups, halogen groups, ether groups and thioether groups.

Examples of suitable ethylenically unsaturated functionalised compounds having at least one alcohol functionality are all compounds containing a hydroxyl group, which may optionally be etherified or esterified, and an ethylenically unsaturated compound, for example allyl and vinyl ethers of alcohols, such as ethyl alcohol and higher branched and unbranched alkyl alcohols, as well as allyl and vinyl esters of alcohol-substituted acids, preferably carboxylic acids and C₃-C₈-alkenyl alcohols. In addition, the alcohols may be substituted by, for example, alkyl and aryl groups, halogen groups, ether groups and thioether groups which do not influence the grafting reaction to an undesired extent.

The amount of the ethylenically unsaturated functionalised compound in the polyolefin polymer functionalised by grafting is preferably in the range from 0.05 to 1 mg eq. per gram of polyolefin polymer. The compatibiliser is especially preferably polyethylene grafted to maleic anhydride or polypropylene grafted to maleic anhydride.

The amount of compatibiliser, relative to the polymer in the core of the microspheres, is, for example, in the range 0.1-10% by weight and is preferably 1-5% by weight.

Both the polymer in the core and also the polymer in the shell are preferably, independently of one another, thermoplastic polymers, since this simplifies the mixing of the absorber(s) into the polymer in the core or of the microspheres into a polymer matrix, for example a plastic composition, in order to make it suitable for laser writing.

If the polymer in the core and the compatibiliser in the shell contain functional groups, these functional groups may be bonded to one another. Thus, the core of the microspheres is surrounded by a shell which is either chemically or physically bonded to the polymer in the core via the respective functional groups.

The present invention furthermore relates to the use of the microspheres as laser-inscription additive. The use of the microspheres as laser-absorbing additive in a polymer matrix, for example a plastic composition, shows an optimum colour-formation ability. The activity of the microspheres appears to be based on the transmission of the energy absorbed from the laser light to the polymer in the core. The polymer may decompose due to this release of heat, causing the colour change.

The absorbers are present in the microspheres, for example, in the form of particles. The particle size of the absorbers is determined by the requirement that the absorbers must be capable of being mixed into the polymer in the core. It is known to a person skilled in the art in the area that this miscibility is determined by the total surface area of a certain amount by weight of absorber and that the person skilled in the art will readily be able to determine the lower limit of the particle size of the absorbers to be mixed in if the desired size of the microspheres and the desired amount of absorber to be mixed in are known.

Finally, the core/shell particles are dispersed in a carrier polymer which in the present invention is a polyolefin. This polyolefin matrix preferably contains absolutely no functional groups. The polyolefin is preferably a polyethylene or a polypropylene. The polyolefin matrix is particularly preferably a polyolefin selected from the group linear low-density polyethylene (LLDPE), very low-density polyethylene (VLDPE), low-density polyethylene (LDPE) or a metallocene-polyethylene (m-PE) and very particularly preferably an LLDPE. The same polymers as those mentioned for the compatibiliser, albeit in their non-functionalised form, may be considered as carrier polymer. The amount of carrier polymer is preferably in the range 20-60% by weight of the entire polymer (i.e. the entire formulation) comprising core, shell and absorbers.

In a particularly preferred embodiment, the microspheres according to the invention consist, in accordance with the present application, of

10-50% by weight of carbon/metal oxide (=core)

10-40% by weight of PPO/PS or PBT (=core)

0.5-7.5% by weight of grafted polyolefin (=shell)

20-60% by weight of polyolefin (=carrier polymer)

0-5% by weight of one or more additives

or

10-50% by weight of carbon/metal titanate (=core)

10-40% by weight of PPO/PS or PBT (=core)

0.5-7.5% by weight of grafted polyolefin (=shell)

20-60% by weight of polyolefin (=carrier polymer)

0-5% by weight of one or more additives

or

10-50% by weight of carbon/metal oxide (=core)

10-40% by weight of PPO/PS or PBT (=core)

0.5-7.5% by weight of SEBS (=shell)

20-60% by weight of polyolefin (=carrier polymer)

0-5% by weight of one or more additives

or

10-50% by weight of carbon/metal titanate (=core)

10-40% by weight of PPO/PS or PBT (=core)

0.5-7.5% by weight of SEBS (=shell)

20-60% by weight of polyolefin (=carrier polymer)

0-5% by weight of one or more additives

where the total % by weight is 100%, based on the microspheres dispersed in the polyolefin matrix (=carrier polymer).

The polymer in the core, in the shell and in particular the carrier polymer may additionally comprise one or more additives, such as, for example, pigments, colorants and/or dyes or a mixture thereof. This has the advantage that a separate coloured masterbatch does not have to be added if the microspheres are mixed with a polymer matrix, such as a plastic or resin.

With respect to their size, the microspheres according to the invention preferably have an average diameter in the range 0.5-10 μm and especially preferably in the range 0.5-5 μm.

In order to provide a laser-inscribable composition, the microspheres according to the invention are incorporated, for example, into a polymer matrix, for example a plastic composition. It is also possible to select the polymer matrix to be marked as the carrier polymer for the microspheres.

The present invention also relates to a process for the production of the microspheres according to the invention. In a preferred embodiment, the microspheres are produced by means of extrusion or reactive extrusion. In a first step, the absorber is prepared from carbon and metal oxide or metal titanate. This is preferably carried out by mixing the elemental carbon, for example carbon black, with one or more metal oxides and/or one or more metal titanates, preferably in a drum hoop mixer. The agglomerates generally formed, usually in the form of spheres, are then sieved to a suitable particle size and subsequently mixed with the core-forming polymer in the melt. The ratio between the amount of the core-forming polymer and the amount of absorber(s) is preferably in the range 90-10% by weight:25-75% by weight. In the second step, the mixture of absorber(s) and polymer melt is mixed with the compatibiliser. This mixing is preferably carried out above the melting point of both polymer and compatibiliser, preferably in the presence of an amount of a non-functionalised carrier polymer. Suitable carrier polymers are, in particular, those which have been mentioned above for the compatibiliser, but in their non-functionalised form. This carrier polymer does not have to be the same as the compatibiliser. The presence of a non-functionalised carrier polymer ensures suitable melt-processability of the entire mixture, so that the desired homogeneous distribution of the microspheres is obtained.

In order to obtain a laser-inscribable polymer composition, the microspheres according to the invention are mixed into a polymer matrix. The polymer matrix comprising the microspheres according to the invention exhibits very high contrast compared with the laser-markable polymers or plastics from the prior art and can at the same time be inscribed at very high speed.

The present invention therefore also relates to a laser-inscribable composition which comprises a polymer matrix and the microspheres according to the invention.

All known polymers, such as, for example, plastics, binders, resins, etc., can be employed for the laser-inscription and laser-welding application. Suitable plastics are, for example, thermoplastics and thermosets, such as, for example, polyethylene (PE), polypropylene (PP), polyamide (PA), polyester, polyether, polyphenylene ether, polyacrylate, polyurethane (PU), polyoxymethylene (POM), polymethacrylate, polymethyl methacrylate (PMMA), polyvinyl acetate (PVAC), polystyrene (PS), acrylonitrile-buta-diene-styrene (ABS), acrylonitrile-styrene-acrylate (ASA), ABS graft polymer, polybutylene terephthalate (PBT), polyethylene terephthalate (PET), polyvinyl chloride (PVC), polyvinylidene chloride (PVDC), polyvinylidene fluoride (PVDF), polytetrafluoroethylene (PTFE), polycarbonate (PC), polyether sulfones, polyether ketone, thermoplastic polyurethane (TPU), thermoplastic elastomers (TPE), epoxy resin (EP), silicone resin (SI), unsaturated polyester resin (UP), phenol-formaldehyde resin (PF), urea-formaldehyde resin (UF), melamine resin (MF) and copolymers thereof and/or mixtures thereof. The polymer may also be a copolymer or block copolymer, etc. The polymer matrix to be marked may furthermore also comprise conventional and suitable additives.

Examples of preferred polymers are all PE and PP grades known to the person skilled in the art, in particular ultrahigh-molecular-weight polyethylene (UHMWPE), for example from Solpor™, styrene plastics, including ABS, styrene-acrylonitrile (SAN) and polymethyl (meth)acrylate, polyurethane, polyesters, including PET and PBT, polyoxymethylene (POM), polyvinyl chloride (PVC), polyethylene (PE), polypropylene (PP), polyamide (PA), polyurethane (PU), thermoplastic vulcanisates, such as, for example, Santoprene™ and SARLINK®, thermoplastic elastomers, such as, for example, Hytrel® and Arnitel®, and silicone rubbers, such as, for example, Cenusil® and Geniomer®.

The laser-inscribable composition in accordance with the present invention may also comprise further additives of which it is known, for example, that they improve certain properties of the polymer matrix or impart further properties on it. Examples of suitable additives are, inter alia, reinforcing materials, such as glass fibres and carbon fibres, nanofillers, such as clays, including wollastonite, mica, pigments, dyes, colorants, fillers, such as calcium carbonate, talc, processing assistants, stabilisers, antioxidants, plasticisers, impact modifiers, flame retardants, mould release agents, foaming agents, etc.

The amount of absorber in the polymer matrix can extend from very small amounts, such as, for example, 0.05% by weight, to 5% by weight, based on the entire composition. The microspheres according to the invention are generally employed in amounts such that no or little influence on the contrast of the laser inscription result is observed on irradiation of the polymer composition to be inscribed.

Typical ranges for the concentrations of the microspheres according to the invention in the polymer matrix for the laser inscription are indicated below. For laser inscription, 0.2-5% by weight, preferably 0.2-2% by weight, of the microspheres according to the invention (complete formulation including carrier polymer), based on the polymer matrix, are generally employed.

The laser-inscribable composition according to the invention can be prepared by simply mixing the microspheres according to the invention into the molten polymer matrix, such as, for example, a plastic composition.

In general, the incorporation of the microspheres within the polymer matrix is carried out by simple mixing with the plastic pellets (=polymer matrix) and optionally with further additives and/or dyes and/or colorants, followed by thermal shaping by exposure to heat. During the incorporation of the microspheres, the plastic pellets can optionally be treated with adhesion promoters, organic polymer-compatible solvents, stabilisers, dispersants and/or surfactants which are resistant at the operating temperatures. The doped plastic pellets are usually produced by adding the plastic pellets to a suitable mixer, wetting them with any desired additives, and then adding and incorporating the microspheres. The plastic is generally pigmented by means of a colour concentrate (masterbatch) or a compound. The resultant mixture can then be processed directly in an extruder or injection-moulding machine. The mouldings formed during processing have a very homogeneous absorber distribution. Finally, the laser inscription or laser welding is carried out using a suitable laser.

The polymer composition to be inscribed, for example a plastic, is generally inscribed or welded by means of suitable laser irradiation as follows.

In the laser-inscription method, the sample is placed in the ray path of a pulsed laser beam, preferably an Nd:YAG laser or Nd:YVO₄ laser. The inscription can also be carried out using a CO₂ laser, for example using a mask technique. The desired results can also be achieved using other conventional types of laser whose wavelength is within the region of high absorption of the microspheres used. The inscription obtained is determined by the irradiation duration (or number of pulses in the case of a pulsed laser) and by the power emitted by the laser and also by the polymer matrix used. The power of the laser used depends on the specific application and can readily be determined by a person skilled in the art.

In the case of laser inscription, the laser used generally has a wavelength in the range from 157 nm to 10.6 μm, preferably in the range from 532 nm to 10.6 μm. Examples which may be mentioned are a CO₂ laser (10.6 μm) and an Nd:YAG laser (1064 nm, 532 nm or 355 nm), as well as a pulsed UV laser. Excimer lasers have the following wavelengths: F₂ excimer laser: 157 nm, ArF excimer laser: 193 nm, KrCl excimer laser: 222 nm, KrF excimer laser: 248 nm, XeCl excimer laser: 308 nm, XeF excimer laser: 351 nm, and frequency-multiplied Nd:YAG laser: wavelength of 355 nm (frequency-tripled) or 265 nm (frequency-quadrupled). Particular preference is given to the use of Nd:YAG lasers (1064 or 532 nm) and CO₂ lasers. The energy densities of the lasers used are generally within the range from 0.3 mJ/cm² to 50 J/cm², preferably from 0.3 mJ/cm² to 10 J/cm².

If pulsed lasers are used, the pulse frequency is generally within the range from 1 to 150 kHz. Corresponding lasers which can be used in the process according to the invention are commercially available.

The inscription using the laser is preferably carried out by introducing the article into the ray path of a CO₂ laser (10.6 μm) or a pulsed laser, preferably an Nd:YAG laser.

The laser welding is carried out by introducing the sample into the ray path of a continuous wave laser, preferably an Nd:YAG or diode laser. The wavelengths are preferably between 808 and 1100 nm. Since most polymers are more or less transparent at these wavelengths, the absorption property is achieved by the addition of the microspheres according to the invention. Welding using other conventional types of laser is likewise possible if they operate at a wavelength at which the absorber in the microspheres used exhibits high absorption. The welding is determined by the irradiation duration and the irradiation power of the laser and the plastic system used. The power of the lasers used depends on the particular application and can readily be determined for the individual case by a person skilled in the art.

The polymer compositions which comprise the microspheres as laser-inscription additive according to the invention can be used in any desired area in which conventional printing processes have hitherto been used for the inscription or marking of plastics. Virtually any plastic article can be obtained in laser-markable or laser-inscribable form. Any article which consists of a polymer matrix, such as, for example, a plastic, can be provided with function data, bar codes, logos, graphics, pictures and identification codes. In addition, they can be used
in medical equipment, such as tubes, containers for tissue samples or fluids, syringes, pots, covers, catheters,
in the automobile sector, for example for fluid containers, cabling, components,
in the telecommunications and E&E sectors, for example for GSM fronts, keyboards, microswitches,
in security and identification applications, such as, for example, credit cards, identification cards, animal identification tags, labels, security strips,
in marketing applications, such as, for example, logos, decoration on corks, golf balls, promotional articles,
in packaging, such as, for example, single- and multilayered films, bot-ties, caps and closures, including, but not limited to, screw caps for bottles, security closures and synthetic corks.

For example, mouldings made from the plastics doped in accordance with the invention can be used in the electrical industry, electronics industry or motor vehicle industry. With the aid of laser light, it is possible to produce identification markings or inscription markings even at points to which access is difficult, for example on cables, lines, decorative strips or functional parts in the heating, ventilation or cooling sector or on switches, plugs, levers or handles which consist of the plastic according to the invention.

The polymer system according to the invention can also be used for packaging in the food and drinks sector or in the toys sector. The inscriptions on the packaging are wipe- and scratch-resistant, resistant during downstream sterilisation processes, and can be employed in a hygienically clean manner during the inscription process. Complete label motifs can be applied in a durable manner to packaging of reusable systems.

A further important application sector for laser inscription is the inscription of plastics for the production of individual identification markings for animals, which are known as cattle ear tags or simply ear tags. The information specifically associated with the animal is stored via a bar code system. It can be called up again when required with the aid of a scanner. The inscription must be extremely resistant, since some tags remain on the animals for many years.

Laser welding with the microspheres according to the invention can be carried out in all areas in which conventional joining methods are employed and in which it was hitherto not possible to employ the welding process owing to laser-transparent polymers or pale colours. The welding process for laser-transparent plastics thus represents an alternative to conventional joining methods, for example high-frequency welding, vibration welding, ultrasound welding, hot-air welding or also adhesive bonding of plastic parts.

The following examples are intended to explain the invention, but not to restrict it. The percentages relate to the weight, unless indicated otherwise.

### EXAMPLES

Process for the preparation of a laser-marking absorber concentrate (LMAC, Table 1) and the comparative compounding concentrate (CCC, Table 1.1)

using

as the first polymer (core polymer):
P1.0 Arnite T 04/200 polybutylene terephthalate 1060 (DSM)
P1.1 Noryl 6850H-100 (mixture of PPO/PS 50/50, Sabic®)
P1.2 Makrolon 2807 polycarbonate (Bayer)
P1.3 Polyclear 1101 polyethylene terephthalate (Invista)

as the second polymer (shell: compatibiliser):
P2.0 Fusabond® 525N polyethylene (Dupont), grafted to 0.9% by weight of MA
P2.1 Kraton 1650G (Kraton Performance Polymers)

as the third polymer (carrier polymer):
P3 linear low-density polyethylene (LLDPE Sabic) M500026 as the absorber:
A-1 Kronos 2900 TiO₂ (Kronos)/Printex 90 carbon black (Degussa) 99.96% by weight/0.04% by weight
A-2 Iriotec™ 8825 (Merck KGaA)
A-3 Iriotec™ 8208 (Merck KGaA)
A-4 barium titanate powder 99.9% nano (ABCR)/Printex 90 carbon black (Degussa) 99.95% by weight/0.05% by weight

as polymer matrix:
M-1 linear low-density polyethylene M500026 (Sabic).

Process for the preparation of a laser-marking absorber concentrate (LMAC, Table 1) and the comparative compounding concentrate (CCC, Table 1.1)

A series of laser-marking absorber concentrates LMAC 01-LMAC 05 and comparative compounding concentrates CCC 01-CCC 04 is prepared using a twin-screw extruder (Leistritz Mikro 27).

The compositions of the LMACs and CCCs are indicated in Tables 1 and 1.1 respectively.

The mixture of TiO₂ (Kronos 2900) and carbon black (Printex 90, Evonik) is pre-mixed in a tumble mixer and subsequently sieved through a 2.5 mm sieve. The mixture of barium titanate (ABCR) and carbon black (Printex® 90, Evonik) is pre-mixed in a tumble mixer.

The most important extruder parameters are likewise indicated in Tables 1 and 1.1.

TABLE 1
Composition of the laser-marking absorber concentrates

| | Compound | | | | |
|---|---|---|---|---|---|
| | LMAC 01 | LMAC 02 | LMAC 03 | LMAC 04 | LMAC 05 |
| First | P1.0 | P1.1 | P1.2 | P1.3 | P1.1 |
| polymer | 50 | 50 | 25 | 50 | 50 |
| Absorber | A-1 | A-1 | A-1 | A-1 | A-4 |
| | 50 | 50 | 75 | 50 | 50 |
| Rotational | 250 | 250 | 250 | 250 | 250 |
| speed [rpm] | | | | | |
| Throughput | 20 | 20 | 12 | 15 | 15 |
| [kg/h] | | | | | |
| Material | 265 | 265 | 286 | 285 | 261 |
| temperature | | | | | |
| [° C.] | | | | | |
| Heating zone | 265 | 265 | 290 | 290 | 265 |
| 1 [° C.] | | | | | |
| Heating zone | 260 | 260 | 280 | 280 | 255 |
| 10 [° C.] | | | | | |

TABLE 1.1
Composition of the comparative compounding concentrates

Compound

| | CCC 01 | CCC 02 | CCC 03 | CCC 04 |
|---|---|---|---|---|
| Polymer matrix | M-1 | M-1 | M-1 | M-1 |
| | 97 | 95 | 90 | 95 |
| Absorber | A-1 | | | |
| | 3 | | | |
| Absorber | | A-2 | | |
| | | 5 | | |
| Absorber | | | A-3 | |
| | | | 10 | |
| Absorber | | | | A-4 |
| | | | | 5 |

Process for the Preparation of the Laser-Marking Concentrates (LMCs)

A series of laser-marking concentrates LMC 01-LMC 05 is prepared using a twin-screw extruder (Leistritz Mikro 27). The composition of the LMCs and the most important extruder parameters are indicated in Table 2.

TABLE 2
Composition of the laser-marking concentrates

| | Compound | | | | |
|---|---|---|---|---|---|
| | LMC 01 | LMC 02 | LMC 03 | LMC 04 | LMC 05 |
| LMAC 01 | 50 | | | | |
| LMAC 02 | | 50 | | | |
| LMAC 03 | | | 50 | | |
| LMAC 04 | | | | 50 | |
| LMAC 05 | | | | | 50 |
| 2nd | P2.0 | P2.1 | P2.0 | P2.0 | P2.1 |
| polymer | 1.5 | 1.5 | 1.5 | 1.5 | 1.5 |
| 3rd polymer | P3 | P3 | P3 | P3 | P3 |
| | 48.5 | 48.5 | 48.5 | 48.5 | 48.5 |
| Rotational | 30 | 300 | 300 | 300 | 300 |
| speed [rpm] | | | | | |
| Throughput | 20 | 20 | 16 | 20 | 20 |
| [kg/h] | | | | | |
| Material | 285 | 285 | 286 | 266 | 286 |
| temperature | | | | | |
| [° C.] | | | | | |
| Heating | 280 | 280 | 300 | 300 | 280 |
| zone 1 [° C.] | | | | | |
| Heating | 280 | 280 | 280 | 260 | 280 |
| zone 10 | | | | | |
| [° C.] | | | | | |

Process for the Preparation of the Laser-Marking Diluted Concentrates (LMDCs)

A series of laser-marking diluted concentrates LMDC 01-LMDC 05 is prepared using a twin-screw extruder (Leistritz Mikro 27). The composition of the LMDCs is indicated in Table 3. The screw speed is 200 revolutions per minute and the throughput is 10 kg/h. In the case of the diluted concentrates LMDC 01-LMDC 05, the temperature in zone 1 is 220° C. and the temperature in zone 10 is 220° C.

TABLE 3
Composition of the laser-marking diluted concentrates

| | LMDC 01 | LMDC 02 | LMDC 03 | LMDC 04 | LMDC 05 |
|---|---|---|---|---|---|
| LMC 01 | 10 | | | | |
| LMC 02 | | 10 | | | |
| LMC 03 | | | 10 | | |
| LMC 04 | | | | 10 | |
| LMC 05 | | | | | 10 |
| Polymer | M-1 | M-1 | M-1 | M-1 | M-1 |
| matrix | 90 | 90 | 90 | 90 | 90 |

Process for the Production of a Laser-Marking Product (LMP)

Laser-marking products were produced using a twin-screw extruder (Leistritz Mikro 27). The composition of the LMPs is indicated in Table 4. The screw speed is 200 revolutions per minute and the throughput is 10 kg/h. In the case of the diluted concentrates LMP 01-LMP 05, the temperature in zone 1 is 220° C. and the temperature in zone 10 is 220° C.

TABLE 4
Composition of the laser-marking products (LMPs)

| | Compound | | | | |
|---|---|---|---|---|---|
| | LMP 01 | LMP 02 | LMP 03 | LMP 04 | LMP 05 |
| LMDC 01 | 20 | | | | |
| LMDC 02 | | 20 | | | |
| LMDC 03 | | | 20 | | |
| LMDC 04 | | | | 20 | |
| LMDC 05 | | | | | 20 |
| Polymer | M-1 | M-1 | M-1 | M-1 | M-1 |
| matrix | 80 | 80 | 80 | 80 | 80 |

Preparation of Laser-Marking Samples

Laser-markable samples (LMSAs) are produced by injection moulding. The composition of the LMSAs is indicated in Tables 5a, 5b and 5c. The temperature in zone 1 is set to 220° C. for all samples. The temperature in zone 2 is 225° C., the temperature in zone 3 is 230° C., the temperature in zone 4 is 235° C. and the temperature at the nose overall is 220° C.

TABLE 5a
Composition of laser-marking samples

| | LMSA | LMSA | LMSA | LMSA | LMSA | LMSA | LMSA | LMSA | LMSA |
|---|---|---|---|---|---|---|---|---|---|
| | 01 | 02 | 03 | 04 | 05 | 06 | 07 | 08 | 09 |
| LMP 01 | 100 | 50 | 25 | | | | | | |
| LMP 02 | | | | 100 | 50 | 25 | | | |
| LMP 03 | | | | | | | 100 | 50 | 25 |
| Polymer | | M-1 | M-1 | | M-1 | M-1 | | M-1 | M-1 |
| matrix | | 50 | 75 | | 50 | 75 | | 50 | 25 |

TABLE 5b
Composition of laser-marking samples

| | LMSA | LMSA | LMSA | LMSA | LMSA | LMSA |
|---|---|---|---|---|---|---|
| | 10 | 11 | 12 | 13 | 14 | 15 |
| LMP4 | 100 | 50 | 25 | | | |
| LMP5 | | | | 100 | 50 | 25 |
| Polymer | | M-1 | M-1 | | M-1 | M-1 |
| matrix | | 50 | 75 | | 50 | 75 |

TABLE 5c
Composition of laser-marking samples

| | LMSA | LMSA | LMSA | LMSA | LMSA | LMSA | LMSA | LMSA |
|---|---|---|---|---|---|---|---|---|
| | 16 | 17 | 18 | 19 | 20 | 21 | 22 | 23 |
| Polymer | M-1 | M-1 | M-1 | M-1 | M-1 | M-1 | M-1 | M-1 |
| matrix | | 90 | 95 | 97.5 | 90 | 95 | 97.5 | 90 |
| CCC 01 | 100 | | | | | | | |
| CCC 02 | | 10 | 5 | 2.5 | | | | |
| CCC 03 | | | | | 10 | 5 | 2.5 | |
| CCC 04 | | | | | | | | 10 |

Laser-Inscription Performance

Laser-inscription evaluations are carried out using a Trumpf VMc5 11 watt diode-pumped IR laser system. So-called evaluation matrices are em-bossed. In such matrices, the inscription speed (v [mm/sec]) and frequency (f [kHz]) are varied for a given power (p [%]), focal distance (z=0 [at the focus] or 10 mm above the sample) and line spacing. The evaluation matrices essentially indicate what contrast can be obtained at a particular inscription speed while varying the laser parameters. An evaluation of the laser-inscription performance with respect to contrast and inscription speed, indicated by + and − in the range from excellent (+++++) to poor (−−−−−), is given in Table 6.

TABLE 6
Evaluation of the laser-inscription performance of the LMSAs at a
laser power of 95% and a line speed between 1000 and
5000 mm/min

| | Matrix | | Micro- | Content | Inscription |
|---|---|---|---|---|---|
| Sample | polymer | Absorber | spheres | [% by wt.] | performance |
| LMSA 01 | M1 | A-1 | yes | 0.5 | +++ |
| LMSA 02 | M1 | A-1 | yes | 0.25 | ++ |
| LMSA 03 | M1 | A-1 | yes | 0.125 | ++ |
| LMAS 04 | M1 | A-1 | yes | 0.5 | +++++ |
| LMSA 05 | M1 | A-1 | yes | 0.25 | ++++ |
| LMSA 06 | M1 | A-1 | yes | 0.125 | +++ |
| LMSA 07 | M1 | A-1 | yes | 0.5 | ++++ |
| LMSA 08 | M1 | A-1 | yes | 0.25 | +++ |
| LMSA 09 | M1 | A-1 | yes | 0.125 | ++ |
| LMSA 10 | M1 | A-1 | yes | 0.5 | +++ |
| LMSA 11 | M1 | A-1 | yes | 0.25 | ++ |
| LMSA 12 | M1 | A-1 | yes | 0.125 | ++ |
| LMSA 13 | M1 | A-4 | yes | 0.5 | +++++ |
| LMSA 14 | M1 | A-4 | yes | 0.25 | ++++ |
| LMSA 15 | M1 | A-4 | yes | 0.125 | +++ |
| LMSA 16 | M1 | A-1 | no | 3.0 | +− |
| LMSA 17 | M1 | A-2 | no | 0.5 | ++++ |
| LMSA 18 | M1 | A-2 | no | 0.25 | +++ |
| LMSA 19 | M1 | A-2 | no | 0.125 | +++ |
| LMSA 20 | M1 | A-3 | no | 1.0 | ++++ |
| LMSA 21 | M1 | A-3 | no | 0.5 | +++ |
| LMSA 22 | M1 | A-3 | no | 0.25 | ++ |
| LMSA 23 | M1 | A-4 | no | 0.5 | + |

¹based on the total amount of the laser-inscribable composition.

1. Microspheres consisting of a core/shell particle dispersed in a polyolefin matrix, characterised in that the core comprises elemental carbon, at least one metal oxide and/or at least one metal titanate and at least one non-olefinic polymer, and the shell comprises at least one compatibiliser.

2. Microspheres according to claim 1, characterised in that the metal oxide is selected from the group TiO₂, ZrO₂, V₂O₅, ZnO, Al₂O₃.

3. Microspheres according to claim 1, characterised in that the metal titanate is selected from the group barium titanate, calcium titanate, magnesium titanate.

4. Microspheres according to claim 1, characterised in that the metal oxide is titanium dioxide.

5. Microspheres according to claim 1, characterised in that the metal titanate is barium titanate.

6. Microspheres according to claim 1, characterised in that the carbon is in the form of carbon black or a black pigment.

7. Microspheres according to claim 1, characterised in that the non-olefinic polymer is a colour former.

8. Microspheres according to claim 1, characterised in that the non-olefinic polymer is PPO/PS, PBT, PET or PC.

9. Microspheres according to claim 1, characterised in that the compatibiliser is a functionalised polymer.

10. Microspheres according to claim 1, characterised in that the compatibiliser is a grafted polymer.

11. Microspheres according to claim 1, characterised in that the compatibiliser is a grafted polyethylene or grafted polypropylene.

12. Microspheres according to claim 1, characterised in that the compatibiliser is polyethylene grafted to maleic anhydride or polypropylene grafted to maleic anhydride.

13. Microspheres according to claim 1, characterised in that the compatibiliser is styrene-ethylene/butylene-styrene (SEBS).

14. Microspheres according to claim 1, characterised in that the polyolefin matrix consists of polyethylene or polypropylene.

15. Microspheres according to claim 1, characterised in that the core, the shell and/or the matrix may additionally each comprise one or more additives.

16. Microspheres according to claim 1, characterised in that the microspheres have an average diameter of 0.5-10 μm.

17. Process for the production of the microspheres according to claim 1 by extrusion or reactive extrusion.

18. (canceled)

19. Laser-inscribable and laser-weldable polymer composition, characterised in that it comprises microspheres according to claim 1.

20. Laser-inscribable and laser-weldable polymer composition according to claim 19, characterised in that the polymer composition consists of polyethylene (PE), polypropylene (PP), polyamide (PA), polyester, polyether, polyphenylene ether, polyacrylate, polyurethane (PU), polyoxymethylene (POM), polymethacrylate, polymethyl methacrylate (PMMA), polyvinyl acetate (PVAC), polystyrene (PS), acrylonitrile-butadiene-styrene (ABS), acrylonitrile-styrene-acrylate (ASA), ABS graft polymer, polybutylene terephthalate (PBT), polyethylene terephthalate (PET), polyvinyl chloride (PVC), polyvinylidene chloride (PVDC), polyvinylidene fluoride (PVDF), polytetrafluoroethylene (PTFE), polycarbonate (PC), polyether sulfones, polyether ketone, thermoplastic polyurethane (TPU), thermoplastic elastomers (TPE), epoxy resin (EP), silicone resin (SI), unsaturated polyester resin (UP), phenol-formaldehyde resin (PF), urea-formaldehyde resin (UF), melamine resin (MF), ultrahigh-molecular-weight polyethylene (UHMWPE), styrene plastics, styrene-acrylonitrile (SAN), thermoplastic vulcanisates, thermoplastic elastomers, silicone rubbers and copolymers thereof and/or mixtures thereof.

21. Process for the preparation of a laser-inscribable and laser-weldable polymer composition according to claim 19, characterised in that the polymer composition is mixed with the microspheres and optionally further additives and finally shaped by exposure to heat.
